(19) United States
(12) Patent Application Publication
(10) Pub. No.: US 2010/0218125 A1
(43) Pub. Date: Aug. 26, 2010

(54) Information processing apparatus, user interface configuration method, and image processing, apparatus, system, and program

(75) Inventor: Ayumi Seki, Tokyo (JP)

Correspondence Address: Harness, Dickey & Pierce P.L.C., P.O. Box 8910, Reston, VA, 20195, US

(73) Assignee: Ricoh Company, Ltd.

(21) Appl. No.: 12/656,834

(22) Filed: Feb. 17, 2010

(30) Foreign Application Priority Data
Feb. 25, 2009 (JP) 2009-042175

(51) Int. Cl. G06F 3/01

(52) U.S. Cl. 715/762

(57) ABSTRACT

An image processing apparatus provided with a user interface (UI) is devised by including a UI display unit, a UI architecture definition obtaining unit, a display controller, a storage unit, a data inheritance unit, and a process execution unit. The UI architecture definition obtaining unit obtains a UI architecture definition. The display controller interprets the UI architecture definition to display the UI. The storage unit stores the UI architecture definition and condition setting data. The data inheritance unit can inherit the condition setting data as new condition setting data. The process execution unit executes information processing using the new condition setting data. The data inheritance unit compares version identification values of new UI and most recent UI architecture definitions. When the values are not identical, the data inheritance unit reads out the condition setting data, and generates the new condition setting data compatible with the new UI architecture definition.

### CROSS-REFERENCE TO RELATED APPLICATIONS

This application claims priority to Japanese Patent Application No. 2009-042175, filed on Feb. 25, 2009 in the Japan Patent Office, which is hereby incorporated by reference herein in its entirety.

### BACKGROUND OF THE INVENTION

1. Field of the Invention

The present invention relates to an information processing technology, and more particularly, to an information processing apparatus, a user interface configuring method, and image processing apparatus, system, and program useable for executing a workflow including a plurality of functions for processing image data.

2. Description of the Background Art

Currently, image processing apparatuses such as multifunctional peripherals (hereinafter referred to as MFP) can provide a plurality of functions such as a copying function, an image forming function, a communication function, or the like. Further, such MFP may be connected to a remote server, in which the server provides a workflow service for processing information (e.g., image data) for the MFP, wherein a workflow may be configured with a plurality of functions implementable by the server in a given sequential order. Such a workflow, composed of plurality of functions for processing image data for a given purpose, can be set up as follows: A user identifies functions to be executed by the MFP and the server, and then designates and sets those functions in a given sequential order. With such a process, a given workflow can be set for the image data. Hereinafter, both the MFP and the server may be referred to as a processing node (or processing unit).

Several methods to set and execute a workflow are known. As one example, JP-2008-097586-A discloses a method that prepares workflow definition data, and executes a given process or processes on scanned image data based on the workflow definition data. Further, JP-2008-176541-A discloses a method that changes a predetermined layout of a digitized document using metadata attached to the digitized document. Further still, JP-2008-305004-A discloses a method of executing a given application process by integrating software components.

As such, a workflow can be executed for image data relatively easily by implementing a plurality of functions sequentially. Further, currently available image forming apparatuses such as MFP may employ a high-level language such as Java (registered trademark) or Java (registered trademark) Script. In such image forming apparatuses, a user interface, which is used when executing given processes, can be provided by running and a browser program. Further still, plug-in programs can be employed for processing nodes such as the image forming apparatus, server, or the like, by which functions for processing data (e.g., image data) can be added and/or modified relatively easily.

Such functions for processing data may need to be augmented and/or modified to accommodate the need for more complicated workflows or more diversified user requirements. Such process functions may be accessed via a user interface, which may be displayed on a display unit of an information processing apparatus such as an image forming apparatus (e.g., MFP). When a specific information processing function is to be added and/or modified, the user interface, used as an interface for implementing such process function, may also be modified. Hereinafter, “user interface” may be referred to as “UI,” as required.

As for the information processing apparatus, a user may set conditions that in turn establish the data that is useable for a given workflow at any given time. In this case, a given user interface (UI) may be prepared and used for setting such condition setting data. Accordingly, as long as the same UI is used, such condition setting data can be used without problem. However, in some cases, such workflow may be implemented using another UI having a different UI configuration, in which case pre-existing condition setting data in an information processing apparatus or system may not be correctly read or displayed. If the condition setting data is not displayed correctly, modification of existing data becomes difficult, and further, it becomes difficult to determine which condition is already set and which condition is not set. Further still, in a conventional system, even if condition setting data may not be modified, it becomes necessary to read out condition setting data by accessing a hard disk drive or the like every time the condition setting data is read for some purpose. In such a case, history data utilized in past operations may not be effectively utilized.

There is an additional consideration, in that processing nodes or units such as image forming apparatuses and servers, used as components for executing a workflow, may be provided by a vendor, who may also be in charge of services related to apparatus maintenance or the like. Accordingly, when a UI configuration is to be modified, the vendor may conduct such UI modification under certain prescribed circumstances, such as when a specific function is added and/or modified, when a function version is changed, or when customization is requested. Each time a UI configuration is modified, a service person may need to change condition setting data or a user may need to modify workflow definition and re-input condition setting data.

Such inputting processes entail extra work, which is not preferable, and scarce memory resources may be used in a wasted manner due to accumulation of unnecessary data by such inputting process.

As such, in a conventional system or apparatus, an information processing apparatus may manage an image processing apparatus using pre-existing condition setting data set for given functions. However, the pre-existing condition setting data may not be effectively inherited and used when the information processing apparatus UI configuration is modified or changed.

### SUMMARY

In one aspect of the invention, an image processing apparatus including a user interface is devised. The image processing apparatus includes a user interface (UI) display unit, a UI architecture definition obtaining unit, a display controller, a storage unit, a data inheritance unit, and a process execution unit. The user interface (UI) display unit displays the UI. The UI architecture definition obtaining unit obtains a UI architecture definition that defines a configuration of the UI. The a display controller interprets the UI architecture definition and displays the UI on the UI display unit based on the interpretation of the UI architecture definition provided by the display controller. The storage unit stores the UI architecture definition and condition setting data, settable based on an interactive data operation using the UI and useable for a process included in a workflow. The stored condition setting data is useable as pre-existing condition setting data. The data inheritance unit reads the pre-existing condition setting data, and inherits the read pre-existing condition setting data as new condition setting data when the UI architecture definition is to be changed to a new UI architecture definition. The process execution unit executes at least one processing step of information processing, included in the workflow, for image data of the image processing apparatus using the new condition setting data set by the data inheritance unit. The data inheritance unit reads the new UI architecture definition as current UI architecture definition, and compares a version identification value of current UI architecture definition and a version identification value of most recently read UI architecture definition. When it is determined from the version comparison that the version identification value of the current UI architecture definition and the version identification value of the most recently read UI architecture definition are not identical, the data inheritance unit reads out the pre-existing condition setting data used most recently from the storage unit, generates the new condition setting data compatible with the current UI architecture definition, and stores the new condition setting data in the storage unit.

In another aspect of the invention, an information processing apparatus for providing a user interface (UI) used for managing processes executable by an image processing apparatus is devised. The information processing apparatus includes UI architecture definition, a display controller, a storage unit, a network communication device, a data inheritance unit, and a process execution unit. The UI architecture definition obtaining unit obtains a UI architecture definition that defines a configuration of the UI. The a display controller interprets the UI architecture definition and displays the UI on the UI display unit based on the interpretation of the UI architecture definition provided by the display controller. The storage unit stores the UI architecture definition and condition setting data, settable based on an interactive data operation using the UI and useable for a process included in a workflow. The stored condition setting data is useable as pre-existing condition setting data. The network communication device transmits the condition setting data as structured text to the image processing apparatus. The information processing apparatus distributes the condition setting data to the image processing apparatus and instructs the image forming apparatus to read the condition setting data sequentially. The data inheritance unit reads the pre-existing condition setting data; and inherits the read pre-existing condition setting data as new condition setting data when the UI architecture definition is to be changed to a new UI architecture definition. The process execution unit executes at least one processing step of information processing, included in the workflow, for image data of the image processing apparatus using the new condition setting data set by the data inheritance unit. The data inheritance unit reads the new UI architecture definition as current UI architecture definition, and compares a version identification value of current UI architecture definition and a version identification value of most recently read UI architecture definition. When it is determined from the version comparison that the version identification value of the current UI architecture definition and the version identification value of the most recently read UI architecture definition are not identical, the data inheritance unit reads out the pre-existing condition setting data used most recently from the storage unit, generates the new condition setting data compatible with the current UI architecture definition, and stores the new condition setting data in the storage unit.

In another aspect of the invention, a method of setting a user interface (UI) for an image processing apparatus is devised. The method includes the steps of obtaining, storing, reading, comparing, reading out, displaying, and executing. The obtaining obtains a UI architecture definition defining a configuration of the UI. The storing stores the UI architecture definition and condition setting data and condition setting data in a storage unit. The condition setting data is settable based on an interactive data operation using the UI, and useable for a process included in a workflow. The stored condition setting data is useable as pre-existing condition setting data. The reading reads the UI architecture definition. The comparing compares a version identification value of current UI architecture definition and a version identification value of most recently read UI architecture definition. When it is determined that the version identification value of current UI architecture definition and the version identification value of most recently read UI architecture definition are not identical, the reading out reads out the most recently used condition setting data from the storage unit as the pre-existing condition setting data. Based on the pre-existing condition setting data, the generating and storing generates and stores new condition setting data compatible with the UI architecture definition designated by the current UI architecture definition. The displaying displays a UI using the new condition setting data and interpreting the current UI architecture definition. The executing executes at least one processing step of information processing for image data using the new condition setting data.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 illustrates a functional block diagram of an image processing system according to an example embodiment useable for implementing a workflow;

FIG. 2 illustrates a block diagram of a processing node according to an example embodiment, which includes a program execution unit;

FIG. 3 illustrates an example tree structure for a workflow, and example data useable for controlling a workflow and defining a tree structure;

FIG. 4 illustrates data configuration of user interface (UI) generation data according to an example embodiment, which is useable for generating UI;

FIG. 5 illustrates a flowchart for setting a user interface according to an example embodiment;

FIG. 6 illustrates an example condition setting data useable for setting UI;

FIG. 7 illustrates example code used for providing a function of data inheritance unit according to an example embodiment;

FIG. 8 illustrates an example UI display-able on an UI display unit;

FIG. 9 illustrates an example UI architecture definition, useable to set an edition box of FIG. 8;

FIG. 10 illustrates an example UI display prepared according to an example embodiment; and

FIG. 11 illustrates an example case in which UI display is managed for each one of multiple users to prepare a particular UI display.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, Operations, elements, and/or components, but do not preclude the presence or addition of one or more other features, integers, steps, Operations, elements, components, and/or groups thereof.

Furthermore, although in describing expanded views shown in the drawings, specific terminology is employed for the sake of clarity, the present disclosure is not limited to the specific terminology so selected and it is to be understood that each specific element includes all technical equivalents that operate in a similar manner.

Referring now to the drawings, an information processing apparatus or system according to an example embodiment is described. Configurations of the information processing apparatus or system may not be limited to the example embodiment described hereinafter. The information processing apparatus or system may include an image processing apparatus or system.

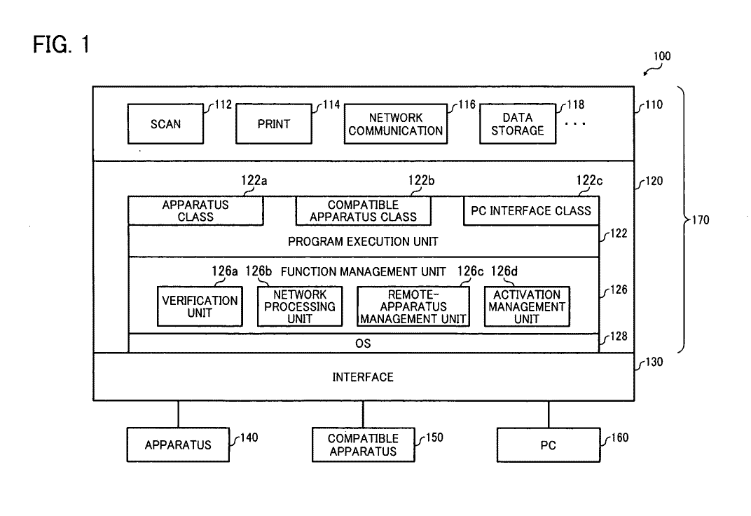

FIG. 1 illustrates a functional block diagram of an image processing system 100 according to an example embodiment, which can set and implement a given workflow. The image processing system 100 may execute various information processing to image data with a given sequence set by a user. Such information processing may include image processing such as image scanning, image format conversion, image compression, and other information processing such as network transmission, printing (or data outputting), data storage, but not limited thereto.

As shown in FIG. 1, the image processing system 100 may include a first processing node 110, and a second processing node 120, for example, wherein the first and second processing nodes 110 and 120 may be connected with each other. Each one of the first and second processing nodes 110 and 120 may be used as a unit to configure a given workflow. The first processing node 110 may be an image forming apparatus such as multi-functional peripherals (MFP), set at a local place such as user site (e.g., business office) for example. The first processing node 110 may include a plurality of functions such as scan 112, print 114, network communication 116, a data storage 118, or the like, but not limited thereto. The second processing node 120 may be an image forming apparatus such as MFP or a server, but not limited thereto. Such first and second processing nodes 110 and 120 may execute a given workflow as follows: the first processing node 110 executes given processes such as given information processing set in a given workflow to image data. Then, the second processing node 120 obtains the image data, processed by the first processing node 110, and executes another given processes set for the given workflow. As such, a workflow may be implemented using one or more processing nodes.

The second processing node 120 may execute given processes to concerned image data such as a format conversion, a communication protocol conversion, but not limited thereto. The second processing node 120 may further execute another given processes such as print data transmission, e-mail (electronic data) transmission, registration of image data to a data base or to an external apparatus such as an image forming apparatus 140 (referred to as apparatus 140 in FIG. 1), a compatible image forming apparatus 150 (referred to as compatible apparatus 150 in FIG. 1), and a personal computer 160 (referred to as PC 160 in FIG. 1), but not limited thereto. The compatible image forming apparatus 150 may be an apparatus, which may be manufactured by one manufacture, different from a manufacture of the image forming apparatus 140. In actual user locations such as business offices, end users may use different types of apparatuses manufactured by different manufactures. Accordingly, the image processing system 100 may need to be adapted to such user environment, which may use various types of information processing apparatuses.

The second processing node 120 may be connected with the image forming apparatus 140, the compatible image forming apparatus 150, and the PC 160 via an interface 130 such as a bus line, the Internet, or a local area network (LAN). For example, the second processing node 120 may transmit an image-processed result to a transfer-destination apparatus using protocol useable in such transfer-destination apparatus.

Further, instead of separating functions of the first processing node 110 and the second processing node 120 in two processing nodes, the image processing system 100 can integrate the first and second processing nodes 110 and 120 as an integrated processing node 170, in which functions of the scan 112, the print 114, the network communication 116, and the data storage 118 of the first processing node 110 may be integrated with the second processing node 120. As such, the first and second processing nodes 110 and 120 may not need to be separated functionally. When the first and second processing nodes 110 and 120 are integrated as the integrated processing node 170, the integrated processing node 170 may be devised as an image forming apparatus (e.g., MFP) including a server function, and the integrated processing node 170 may communicate with the image forming apparatus 140, the compatible image forming apparatus 150, and the PC 160 via a network. Further, the integrated processing node 170 may communicate with an external server (not shown) to set a workflow and manage given processing nodes using plug-in programs. The above described processing nodes may conduct a file-transfer communication (i.e., file-transmission/reception communication) with each other using a given communication protocol such as transmission control protocol/internet protocol (TCP/IP) as communication protocol, and file transfer protocol over secure (FTP(S) and hypertext transfer protocol over secure (HTTP(S)) as file transfer protocol.

When the first processing node 110 and the second processing node 120 are separately used, the second processing node 120 may be devised as an image forming apparatus, a server for administering an image forming apparatus or a personal computer, in which the second processing node 120 may be used as an information processing apparatus including a microprocessor unit (MPU), a random access memory (RAM), a read only memory (ROM), and a hard disk drive, for example. With such configuration, the second processing node 120 may conduct a distributed processing. Further, under a control of operating system (OS) such as UNIX (registered trademark), LINUX (registered trademark), WINDOWS (registered trademark) 200X server, or the like, the second processing node 120 can run a program described by an object-oriented programming such as Java (registered trademark), Java (registered trademark) Script, C++, Perl, Ruby, Python, or the like, but not limited thereto.

Further, the second processing node 120 may be installed with a browser program to execute a file transfer processing with a web server using HTTP(S), for example. The browser program may be Mozilla (registered trademark), Opera (registered trademark), Firefox (registered trademark), Internet Explorer (registered trademark), for example. Such browser program may be used to transmit and receive structured text such as HyperText Markup Language (HTML), Extensible Markup Language (XML), and to display a given UI corresponding to given structured text.

Further, as shown in FIG. 1, the second processing node 120 may include function units such as a program execution unit 122, a function management unit 126, and an OS kernel 128, for example. The program execution unit 122 may include an apparatus class 122a, a compatible apparatus class 122b, and a PC interface class 122c, for example. The apparatus class 122a may provide a support function for an image forming apparatus (e.g., MFP) when the second processing node 120 is used as an image forming apparatus. The compatible apparatus class 122b may provide a compatibility function for another image forming apparatus (e.g., MFP), which is disposed in a given workflow as one processing node, which may be connected via a network. The PC interface class 122c may provide a given support function such as setting data transfer protocol corresponding to PC (e.g., PC 160), disposed in a given workflow as one processing node. In an example embodiment, the apparatus class 122a, the compatible apparatus class 122b, and the PC interface class 122c may employ Java (registered trademark), Virtual Machine (VM), or the like, for example, but may not be limited thereto.

The function management unit 126 may include a verification unit 126a, a network processing unit 126b, a remote-apparatus management unit 126c, and an activation management unit 126d, for example, and may provide functions such as a user verification, a network transaction, a status updating of remotely-disposed apparatus, an operation management of the second processing node 120 as a whole, for example. The OS kernel 128 may manage a program, which may be managed directly by OS, and may enable addition or expansion of functions using plug-in programs.

Further, in another aspect of example embodiment, the program execution unit 122 may be separated from the image forming apparatus 100, and may be included in an information processing apparatus such as server or personal computer, for example. When the program execution unit 122 is separated from the first processing node 110 (e.g., MFP), the PC 160 (see FIG. 1) may include the program execution unit 122, for example, by which the function of the program execution unit 122 can be distributed to the PC 160. Such PC 160 may include a micro-processor unit (MPU), a RAM, a ROM, a hard disk drive, or the like, and the PC 160 may use an object-oriented programming such as Java (registered trademark), Java (registered trademark) Script under a control of given OS such as WINDOWS (registered trademark) series OS, UNIX (registered trademark), LINUX (registered trademark) OS, for example, but not limited thereto.

The PC 160 may be installed with JVM (Java Virtual Machine) to run a program such as Java (registered trademark), in which the PC 160 may run a program using byte code, for example. Further, the PC 160 may be installed with a browser program such as Mozilla (registered trademark), Opera (registered trademark), Firefox (registered trademark), and Internet Explorer (registered trademark), but not limited thereto. Such browser program may be used to set a given workflow.

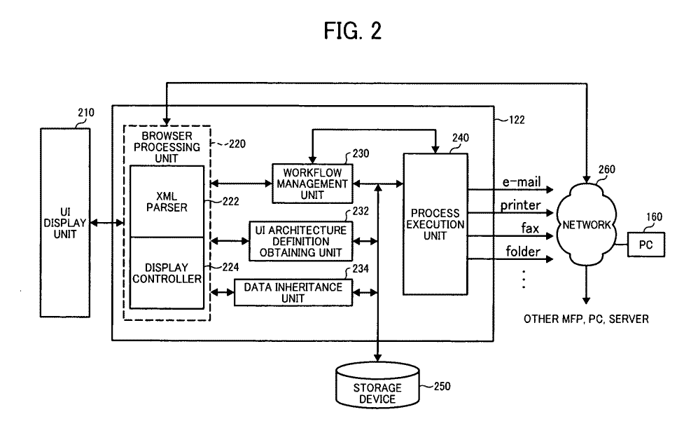

FIG. 2 illustrates a functional block diagram of the program execution unit 122 of the second processing node 120. The program execution unit 122 may function with a configuration shown in FIG. 2, in which a MPU (micro processor unit) reads a program and sets an executionable file on a RAM to execute the program. As shown in FIG. 2, the second processing node 120 may include a user interface display unit 210 (UI display unit 210), a browser processing unit 220 (used as display controller), and a workflow management unit 230, for example. The UI display unit 210 may be devised as a display or operation panel such as a liquid crystal display (LCD), a plasma display (PD), or the like, which can be selectable depending on a design concept of the second processing node 120.

The browser processing unit 220, which may be used as a display controller, may exert its function by executing a browser program in the second processing node 120. Further, the browser processing unit 220 may include a parser 222 (e.g., XML parser) and a display controller 224, for example. The parser 222 reads structured text such as HyperText Markup Language (HTML), Extensible HyperText Markup Language (XHTML), Extensible Markup Language (XML), and provides an interface to execute a designated process based on tag information attached to the structured text. In an example embodiment, the parser 222 may be used as a XML parser, which may include a document object model (DOM) function and simple API for XML (SAX) and interprets tag information using name space.

Further, the display controller 224 may provide a display control function, which matches to property of structured text used for a given system. For example, the display controller 224 may provide cascading style sheet (CSS) function, extensible style sheet language transformation (XSLT) function, or the like, but not limited thereto.

Further, the program execution unit 122 of the second processing node 120 may include an UI architecture definition obtaining unit 232, and a data inheritance unit 234, for example. The UI architecture definition obtaining unit 232 may receive an UI architecture definition from a network 260, and store the UI architecture definition in a storage device 250. Further, in another aspect of example embodiment, UI architecture definition can be displayed on an UI display screen disposed on the UI display unit 210, and then the UI architecture definition can be prepared or generated interactively using the UI display screen on the UI display unit 210. For example, the UI architecture definition may be prepared interactively with a user, a vendor or the like using the UI display screen. In any configurations, the obtained UI architecture definition may be stored in the storage device 250, for example. Based on the UI architecture definition, a UI screen to control a plug-in program may be prepared and displayed on the UI display unit 210.

The data inheritance unit 234 may execute display control to display a UI display screen on the UI display unit 210, wherein the UI display screen may include UI architecture definition received as structured text such as HTML, XHTML, XML, and condition setting data used to control an execution of plug-in program. In an example embodiment, the data inheritance unit 234 may read and determine version information of UI architecture definition, useable for configuring a UI to-be-displayed on a UI display screen. Specifically, the data inheritance unit 234 may determines whether two version information of UI architecture definition matches or not by comparing two version information, in which one version information of UI architecture definition is used to configure a most recently displayed UI displayed, and another version information of UI architecture definition is used to configure a to-be-displayed UI. Based on such determination, a different reading process may be conducted for condition setting data for different UI architecture definition. Such to-be-displayed UI may be referred to as currently-used UI.

The workflow management unit 230 obtains definition of functions described in workflow control data and condition setting data usable to control functions from a storage space such as storage device 250. The workflow management unit 230 calls a sequence of information processing (e.g., sequence of functions) set in a given workflow such as an image data obtaining function, a format conversion function, a printing (or data outputting) function, a data transfer function, a file storing function, or the like. The workflow management unit 230 reports such functions of information processing to a process execution unit 240 to execute the functions of information processing. The process execution unit 240 may call a plug-in program to execute the functions of information processing as a workflow.

The process execution unit 240 maintains a communication with the workflow management unit 230 until all processes set in the workflow are executed, by which the process execution unit 240 completes processes that need to be executed by the second processing node 120.

When the process execution unit 240 completes a last process set in a sequence of functions set for one workflow, the process execution unit 240 may transmit a given process result via a bus or the network 260 to one or more other units, and ends information processing for one workflow in the second processing node 120.

The storage device 250, which may be used as a storage space or area for the second processing node 120, may employ at least one of a hard disk drive, a random access memory (RAM), a buffer memory, an electrically erasable programmable read-only memory (EEPROM) or the like, but not limited thereto. The storage device 250 may store at least workflow control data, UI architecture definition used for generating UI, and condition setting data used for executing a process set for a plug-in program.

When a workflow sequence is to be executed, the program execution unit 122 calls condition setting data for a workflow and UI definition data, used by a plug-in program that executes process. Specifically, the program execution unit 122 sets condition setting data via the browser processing unit 220, and displays an UI screen on the UI display unit 210.

In another aspect of example embodiment, the PC 160 may be used as an information processing apparatus such as a server or personal computer, which may manage, and separately disposed from the program execution unit 122. The PC 160 may include a network communication device such as a network interface card (NIC) so that the PC 160 can access to the network 260. In such configuration, the PC 160 may transfer data via the network 260, for example. The PC 160 may generate workflow definition data and condition setting data as structured text such as XML, and transmits such data (e.g., structured text such as XML) to the second processing node 120 via the network 260, and instructs the second processing node 120 to execute processes defined in a given workflow. As such, the network communication device of information processing apparatus may be used to transmit condition setting data as structured text to an image processing apparatus, for example.

Then, the second processing node 120 may receive workflow definition data, condition setting data, and UI architecture definition from the PC 160 as structured text. Then, the second processing node 120 may read out the received structured text using a XML parser or a document object model (DOM), for example, and set processes included in workflow definition data. Then, the second processing node 120 executes processes set in workflow definition data, wherein the processes may be set using condition setting data.

When a customization of condition setting is not required for the second processing node 120, the second processing node 120 may set condition setting data without any consideration for description order or layout of condition setting data, and the second processing node 120 can set condition setting data without activating the UI display unit 210 such as an operation panel, and executes processes which should be implemented by the second processing node 120. When the second processing node 120 completes its processing, the second processing node 120 executes subsequent processing for the processed data based on workflow definition. For example, the second processing node 120 may transfer the processed data for a printing operation, or to other processing node.

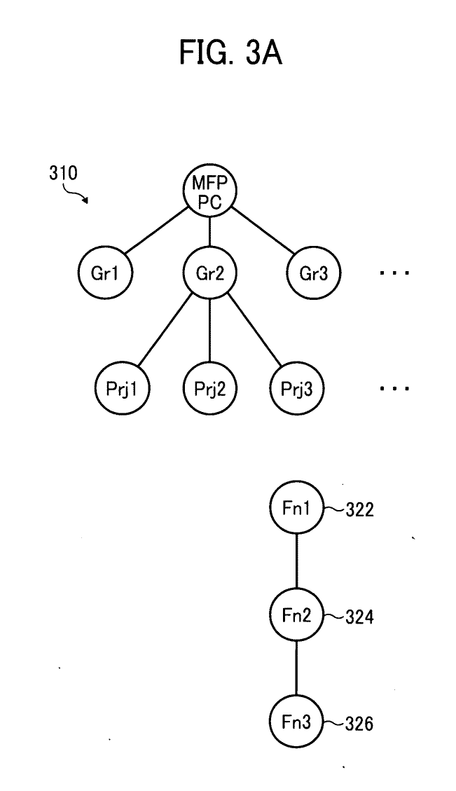

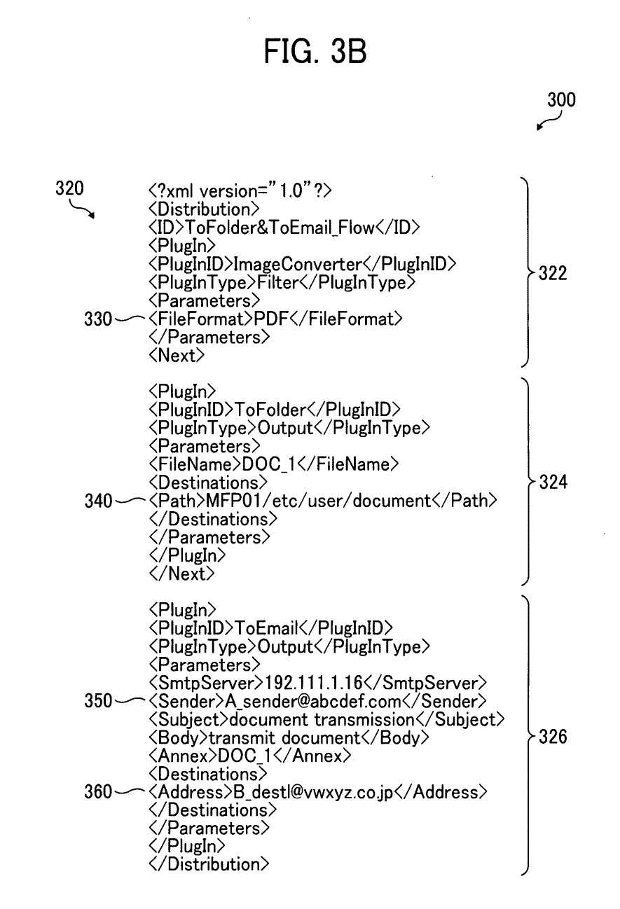

FIG. 3 illustrates an example tree structure and workflow control data defining the tree structure used for a workflow 300. In an example embodiment, the workflow 300 can be defined using a given apparatus. For example, a user can set the workflow 300 interactively using a desktop screen of the PC 160 or an UI display unit of the image forming apparatus used as a processing node. A user interface for setting a workflow is described as known method in JP-2008-97586-A, for example.

FIG. 3 illustrates one example of binary tree structure 310 of the workflow 300. As shown in FIG. 3, a plurality of workflow groups may be set in a parallel manner, for example. Such tree structure of the workflow 300 may set an image forming apparatus as a root node, for example, wherein the image forming apparatus may generate image data. When image data is prepared as digitized data, and registered in a database, the image forming apparatus and the PC 160 may be used as a root node.

The image forming apparatus or PC usable as the root node may be assigned with a profile corresponding to its capability or disposed location, and may be used as a processing node in a workflow. Further, the root node may be coupled with a “child node” to set a given workflow. When the root node is coupled with a plurality of child nodes, a plurality of workflow groups can be set. For example, a plurality of child nodes may share one common function while changing other function for each of the child nodes. For example, in a workflow shown in FIG. 3, the group Gr1 may be registered as “Scan-to-Mail”, the group Gr2 may be registered as “Scan-to-Folder”, and the group Gr3 may be registered as “Scan-to-Print,” in which “Scan-to” function is a common function. To execute such workflow easy-to-use manner, the image forming apparatus or PC may include the UI display unit 210 disposed with an UI button, which is set for each of the groups Gr1 to Gr3.

Further, one workflow group may include a plurality of grandchildren nodes such as projects Pj1, Pj2, Pj3, . . . set for the group Gr2, for example, which may be a user customized group. For example, projects Pj1 to Pj3 may be registered for given jobs, in which each of jobs may be set with given categories such as user-by-user category, destination-by-destination category, or function-by-function category, and each of projects Pj1 to Pj3 may include user customized condition. Further, one project may include discrete jobs such as Fn1 to Fn3 having discrete condition setting data. For example, Fn1 may be a job of image scanning with a resolution of 600 dpi, Fn2 may be a job of portable document format (PDF) conversion, and Fn3 may be a job of e-mail transfer to a specific e-mail address.

The binary tree structure 310 may be described with a structured text such as XML document 320, and the XML document 320 may be used as workflow control data when a processing node implements a workflow. The XML document 320 may include a description of designating a plug-in program for a given information processing, and condition setting data 330, 340, 350, 360 utilized by the plug-in program. Such plug-in program and condition setting data may be set for each one of workflow sequences, for example. In an example embodiment, based on the XML document 320, a processing node used for executing function of project configuring a workflow may refer to contents of XML document 320 related to the concerned function to set a plug-in program, to read out the condition setting data, to start processing of information, and then to transfer processed-information to a subsequent function. A workflow may be configured with one single processing node, but a workflow may be configured with a plurality of processing nodes, in which distributed processing can be configured.

Further, the XML document 320 may include data for setting a filter function 322, a folder storing function 324, and an e-mail transmission function 326 as shown in FIG. 3, which may be used to set a function of obtaining image data, a function of converting data format to PDF, a function of electronic mailing, and a function of storing in folder, for example. A workflow can be conducted by one single processing node. Further, a workflow can be conducted by a distributed processing system, in which one processing node may transfer information to other processing node configuring a workflow. For example, the PC 160 and the second processing node 120 may transfer information to other processing node configuring a workflow.

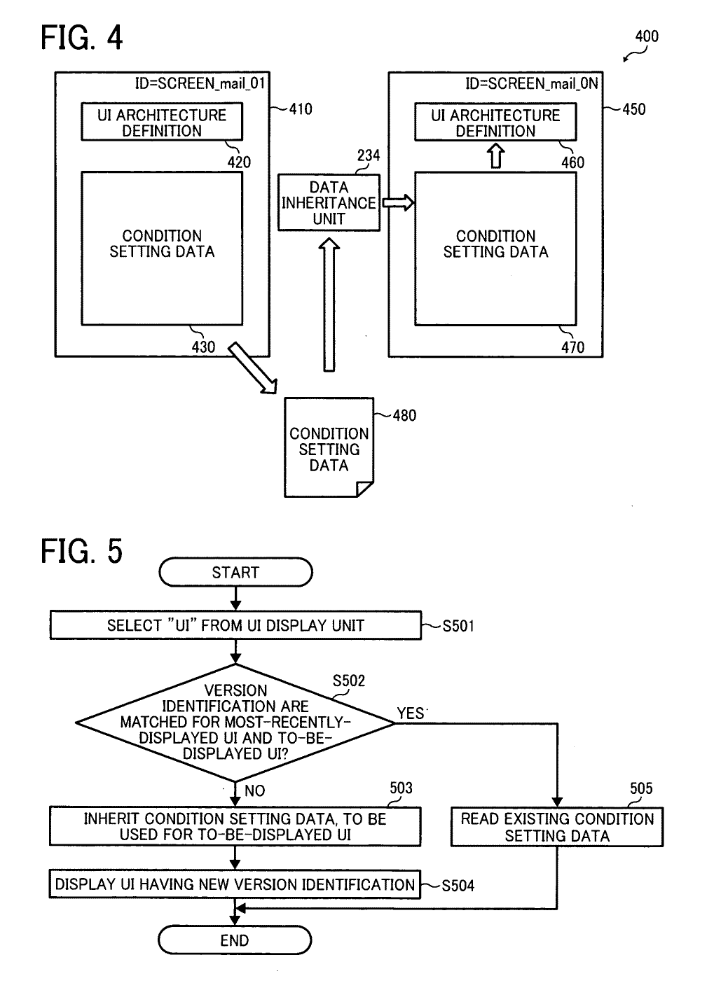

FIG. 4 illustrates a data configuration of UI generation file (or data) according to an example embodiment, useable for generating an UI. The data configuration, useable for displaying a UI on the UI display unit 210, may be assigned with a specific identification value to identify the data configuration, wherein such specific identification value may be referred to as UI identification value. The UI identification value may include a function identification value and a version identification value, for example. The function identification value may specify functions such as electronic mail (e-mail) function, folder storage function, facsimile communication function, or the like, which may be related to a user interface (UI). The version identification value may designate version information of UI architecture definition. For example, a UI architecture definition having version value of “01” useable for electronic mailing is assigned with a UI identification value of “SCREEN_mail_{—}01,” and a UI architecture definition having version value of “ON” is assigned with a UI identification value of “SCREEN_mail_ON” in FIG. 4.

In an example embodiment, an UI generation file may include a UI architecture definition and condition setting data, which are separated with each other or mutually independent each other. For example, an UI generation file 410 may include a UI architecture definition 420 and condition setting data 430, separated with each other, in which the UI architecture definition 420 may utilize the condition setting data 430. The UI architecture definition 420 may be a file, which describes UI part(s), useable for displaying an UI. The condition setting data 430 may be data value, set with an interactive manner using UI parts with by an end user for example, or data value to be set at a given timing. Specifically, as shown in FIG. 4, the UI generation file 410 having ID=SCREEN_mail_{—}01 may be prepared using the UI architecture definition 420 and the condition setting data 430, for example.

The UI architecture definition 420 may use a configuration of XML, HTML, XHTML, HTML including XML, and/or a configuration including CSS or XSLT, for example. Further, the condition setting data 430 may be generated as structured text such as XML, XHTML, and data configuration of the condition setting data 430 may be set in a different manner with respect to the UI architecture definition 420. The condition setting data 430 may be distributed to a processing node that executes a plug-in program. The UI architecture definition and condition setting data may be correlated with each other in view of category of UI, which is to be displayed. For example, UI architecture definition having “ID=SCREEN_mail_{—}01” is correlated to condition setting data having “mail_setting_information,” in which a same reference identification value of “mail” is included.

The UI architecture definition may be modified when a vendor changes a version of plug-in program such as upgrading version of plug-in program. For example, the UI architecture definition 420 is to be modified to a UI architecture definition 460 when a vendor changes a version of plug-in program. When such modification is conducted, a new function may be added, or a UI layout may be modified, in which corresponding layout and types of UI part(s) may also be modified. In this case, the vendor needs to transmit and set the UI architecture definition 460 to a processing node, which conducts a given process. In such processing node, condition setting data customized by a user may be already stored, and such customized condition setting data may be set for a plurality of projects (or discrete projects). Accordingly, it is preferable to utilize such pre-existing condition setting data as much as possible even if a modification of UI architecture definition is to be conducted. Hereinafter, a term of “pre-existing condition setting data” may be used as required, wherein the pre-existing condition setting data may mean a given condition setting data set and stored in apparatus or system at a given timing, and such pre-existing condition setting data may be referred when to set a given UI in view of UI architecture definition. Preferably, a workflow can be effectively utilized if only condition setting data related to a to-be-added/to-be-modified function may be input to implement the workflow. Such configuration may be preferable for effective and efficient utilization of a workflow and enhancing maintenance performance.

In view of such effective and efficient utilization of workflow, the UI architecture definition and the condition setting data may be separately prepared each other in an example embodiment. In FIG. 4, the UI generation file 410 is to be modified to an UI generation file 450, which may be different from the UI generation file 410. The UI generation file 410 may include the UI architecture definition 420 and the condition setting data 430. On one hand, the UI generation file 450 may include an UI architecture definition 460 and a condition setting data 470 to be utilized by the UI architecture definition 460. By using a suitable interface, the pre-existing condition setting data 430 of the UI generation file 410 can be utilized as the condition setting data 470 of the UI generation file 450, in which the pre-existing condition setting data 430 may be referred to a condition setting data 480 when the pre-existing condition setting data 430 is to be inherited and utilized as the condition setting data 470 in the UI generation file 450. If the condition setting data 470 and the condition setting data 430 include common UI items to be displayed, data can be shared between the condition setting data 470 and the condition setting data 430 without no effect of data arrangement order in the condition setting data 480.

In an example embodiment, the data inheritance unit 234 may be employed as an interface to secure such sharing of data. Specifically, the data inheritance unit 234 may refer to the condition setting data 480 to set data, which can be used in common among different UIs, to the condition setting data 470. Such data that can be shared among different UIs can be set to the condition setting data 470 without no effect of description order of such data in a structured text used in the condition setting data 480. For example, the data inheritance unit 234 may use document object model (DOM) to read out data from structured text. Specifically, the data inheritance unit 234 may use DOM to read data from the condition setting data 480, and read-out data may be set as the condition setting data 470, which is useable by the UI generation file 450. With such interface configuration, an addition or increase of software/hardware resources can be preferably set as little as possible.

The data inheritance unit 234 may be described with a script language, which can be interpreted and executed by the browser processing unit 220. For example, such script language may be Java (registered trademark) Script, VBScript (registered trademark), or other script that can be interpreted and executed line-by-line. Such script language is not limited thereto. If an enough resource can be provided for software, an interface may be provided using an execution code of Java (registered trademark), for example.

FIG. 5 illustrates a flowchart of process for setting a user interface (UI) according to an example embodiment. Such user interface setting process may be started when a user instructs a given processing node to display a UI correlated to a workflow. For example, when the processing node receives an instruction to display a UI, such user interface setting process may be started.

At step S501, using the UI display unit 210, an event to designate a specific UI is generated, and an UI identification value of the designated UI is obtained. For example, a specific UI is selected or designated on the UI display unit 210, and then an UI identification value of the selected UI is obtained.

At step S502, a UI identification value of a most-recently-displayed UI and a UI identification value of a to-be-displayed UI (or currently-used UI) are compared. Specifically, a version identification value of UI may be used as the UI identification value, for example. The UI identification value of most-recently-displayed UI may be obtained from log data or the like. Such version identification value of most-recently-displayed UI is compared with a version identification value of currently-used UI. The currently-used UI may be related to a given plug-in to be activated. The to-be-displayed UI may be referred to “currently-used UI,” hereinafter.

If it is determined that the two version identification values are matched at step S502 (S502: YES), the process goes to step S505. At step S505, pre-existing condition setting data is read to display an UI. Then, the process ends at step S506.

At step S505, condition setting data can be read without changing information of UI version. In such situation, the condition setting data utilized for displaying the most-recently-displayed UI can be used, and such condition setting data may have been cached in a given storage, for example. Accordingly, condition setting data can be obtained by accessing such cached condition setting data at step S505. Accordingly, it is not required to access to other unit to read condition setting data. Further, in another aspect of example embodiment that using distributed processing system, the browser processing unit 220 can utilize Cookie to obtain condition setting data, in which condition setting data can be obtained from Cookie and utilized.

On one hand, if it is determined that version identification value of most-recently-displayed UI does not match the version identification value of currently-used UI at step S502, the process goes to step S503. At step S503, the browser processing unit 220 calls the data inheritance unit 234 to execute data inheritance process so that pre-existing condition setting data can be inherited for the currently-used UI display. With such process, a newly-prepared condition setting data corresponding to UI parts, to be used for currently-used UI display having a given version information, can be obtained.

At step S504, the currently-used UI is displayed using the new UI architecture definition set for the currently-used UI having new version identification value. Such new UI architecture definition may have a different configuration compared to the UI architecture definition for most-recently-displayed UI. Although the UI architecture definition may be changed as such, the currently-used UI having the new version identification value can inherit the pre-existing condition setting data as newly-prepared condition setting data. As such, difference of UI architecture definition may not matter for displaying UI having different version identifications. As such, even if modification and/or change of UI version is conducted, pre-existing condition setting data can be effectively utilized by an inheriting process, by which a given workflow process can be implemented as it supposed to be implemented, and then the process ends at step S506.

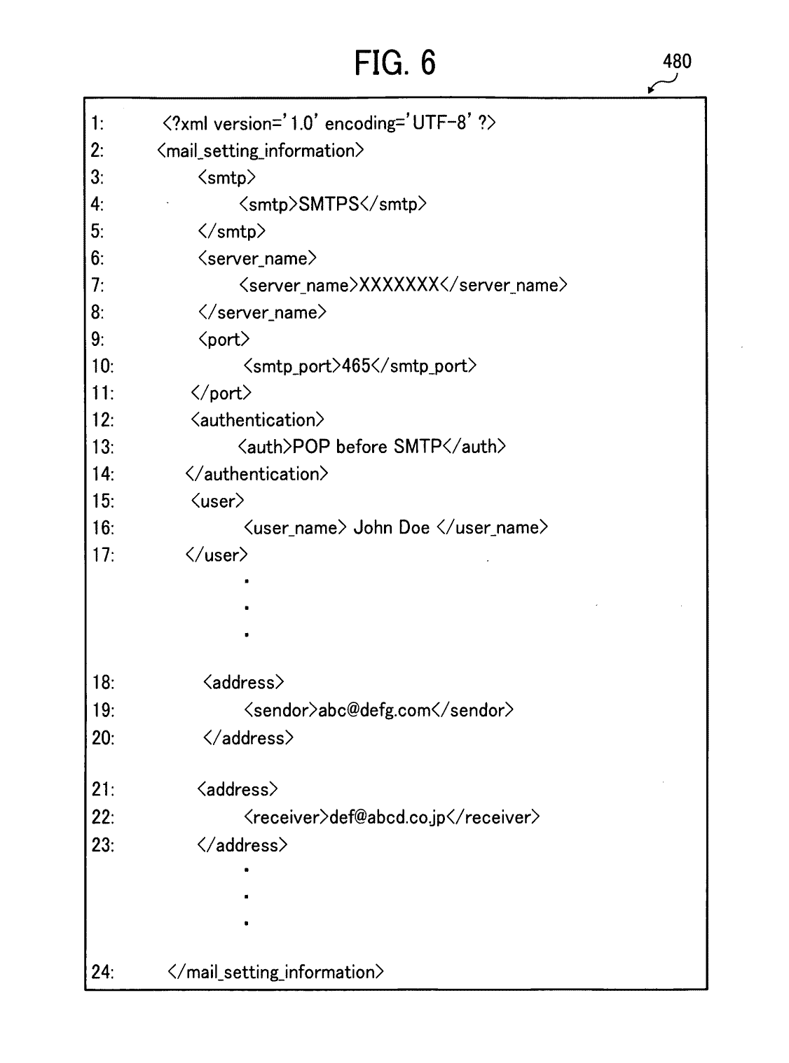

FIG. 6 illustrates one example of the condition setting data 480, which may correspond to the workflow control data 300 shown in FIG. 3. In the condition setting data 480, the first line designates version and encoding information of XML. The second line describes a file name including an identification value for identifying a given function set for UI, which may need to be referred. Then, the subsequent lines describe given tags such as <smp>, <server_name>, <port>, <user>, <address> or the like to define and set a configuration of condition setting data. Such data may be specifically prepared and set to a given processing node by a vendor in advance or by a user as user specific value, for example.

The condition setting data 480 shown in FIG. 6 may be used to control a transmission of electronic mail (e-mail). In an example embodiment, structured text file may be used to set condition setting data for implementing functions such as a folder transmission to transmit data to a folder, a printing function, an image scanning function. Such structured text file may be set in an information processing apparatus or system.

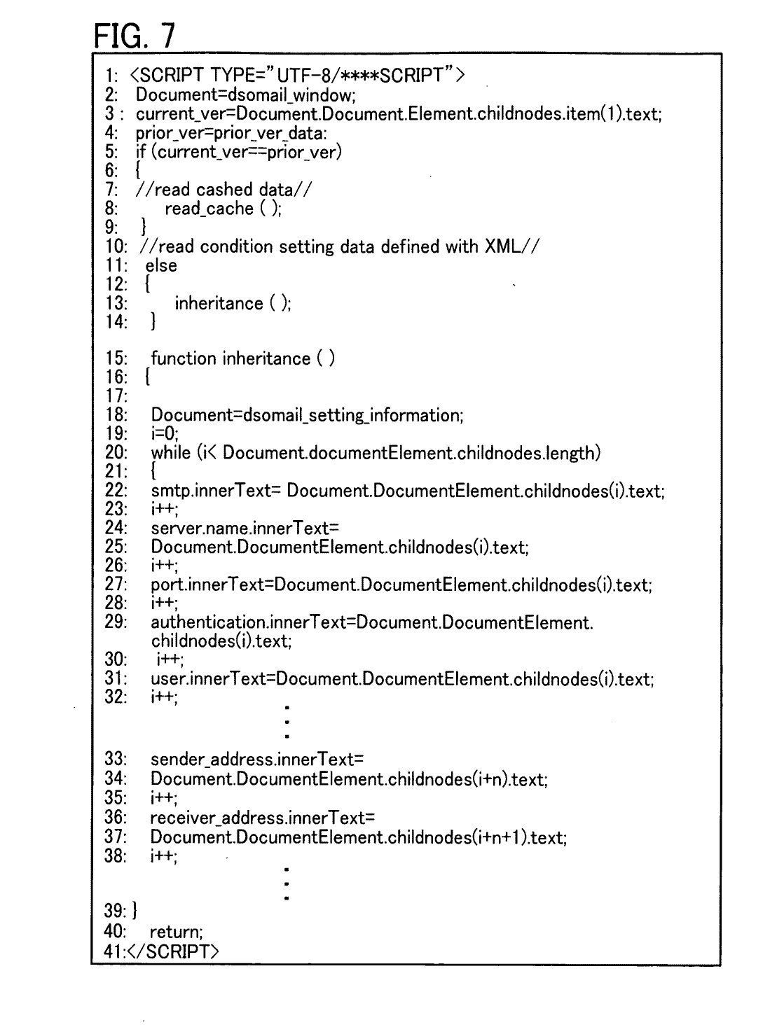

FIG. 7 illustrates an example pseudo-code, which may be useable for the data inheritance unit 234 using a function of DOM, wherein the data inheritance unit 234 may function as an interface. As for the pseudo-code shown in FIG. 7, a version identification value of UI architecture definition, which was read out most recently, is referred to as (prior_ver) of UI architecture definition, and version identification value of UI architecture definition that is to be displayed currently is referred to as (current_ver) of UI architecture definition. Such (prior_ver) and (current_ver) are compared each other. If it is determined that the (prior_ver) and (current_ver) are matched, a function of “read_cache” is activated to read the cached condition setting data, utilized most recently, with a sequential order set for the condition setting data. In contrast, if is determined that the (prior_ver) and (current_ver) are not matched, a function of “inheritance( )” is called to execute data reading, in which the “inheritance( )” function reads out the condition setting data described by XML using DOM, for example.

FIG. 7 illustrates an example code for readout processing using a function of inheritance( ). Specifically, data that needs to be set is read from structured text, which describes condition setting data shown in FIG. 6, in a sequential order of tags set for condition setting data, and then the concerned data may be registered to an address area while receiving a buffering process.

In FIG. 7, the function “inheritance( )” is defined by the line numbers of 15-38, for example. The function “inheritance( )” may call data source object (DSO) to read condition setting data, defined at a given lines, in the pre-existing condition setting data until the “while sentence” loop completes, and set the read value in a buffering process. Variables set for pseudo-code, and Document.DocumentElement.childnodes.length may be used to designate the number of types of condition setting data set by tags, described in the condition setting data. Such data can be obtained in advance using DOM. Further, in another aspect of example embodiment, if the number of condition setting data is defined in advance, such number can be set for each of functions as a constant setting number.

With reference to FIGS. 6 and 7, a description is given to an example processing conducted by the data inheritance unit 234. For example, “smtp_data=Document.DocumentElement.childnodes(i)” described in the 22nd line of pseudo-code (see FIG. 7) is used to read a condition setting data of “SMTPS” shown in FIG. 6, and then a variable “smtp.innerText=SMTPS” is set. Such data reading is sequentially conducted for other items, by which condition setting data can be read from “server_name” to last item and the UI architecture definition, described using HTML, XML, XSLT, and CSS for example, transfers a read-out value of <smtp id=“SMTPS”> as a node <smtp>. By conducting similar processes using given coding, condition setting data used for a new UI architecture definition can be newly prepared and set. The newly set condition setting data is then stored in a storage area or space managed by the program execution unit 122. The stored condition setting data can be retained during a period that the program execution unit 122 is generating an UI instance.

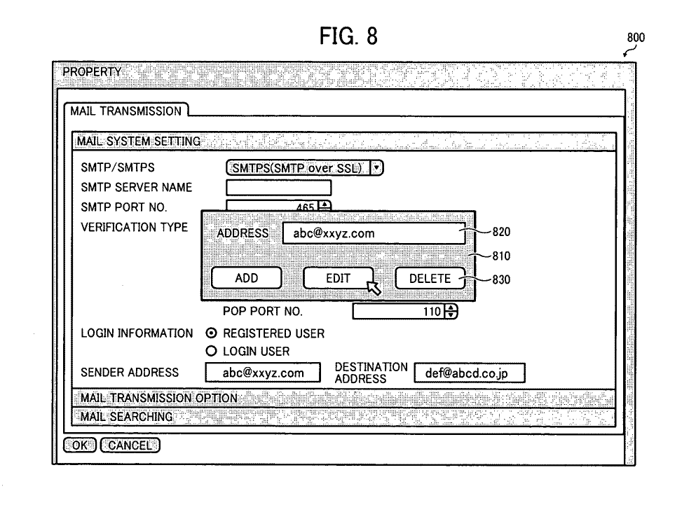

FIG. 8 illustrates one example of a user interface displayable by the UI display unit 210, which may be referred to a user interface 800 (UI 800). The UI 800 may be prepared to set an electronic mailing function for one processing node, for example. Specifically, by operating hotspot set by the UI 800, an UI architecture definition for an edition box 810, to be currently displayed, can be read, wherein a current version of the edition box 810 may be related to hotspot. The edition box 810 may include UI parts such as a text box 820 and a button 830, from which to-be-edit data can be input. For example, a user can add, edit, or delete a sender address using the edition box 810.

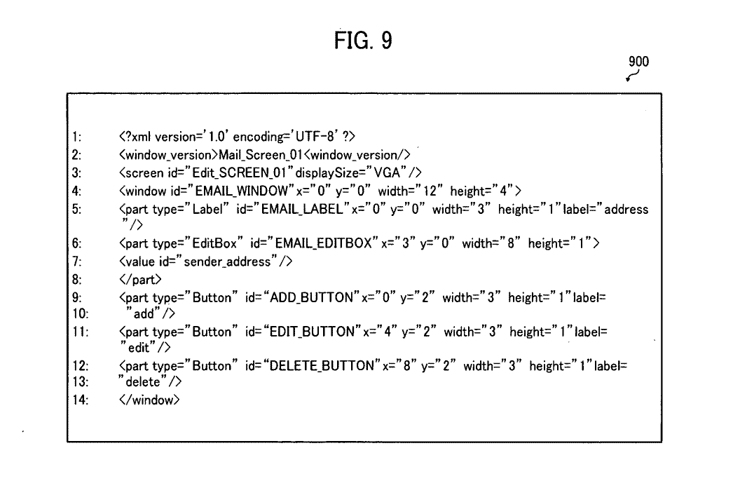

FIG. 9 illustrates an UI architecture definition 900, which is used to prepare the edition box 810 shown in FIG. 8. In the UI architecture definition 900, the 2nd line describes “Mail_Screen_{—}01,” which is an UI identification value used to designate function and version of the UI architecture definition. Further, the 3rd to 5th lines describe data that sets an UI for the edition box 810, which is prepared as a window for setting electronic mailing condition. The edition box 810 may display a default value therein, for example. Such default value may be a cashed value, which has been read and cashed in a cashe memory or a buffer memory by the program execution unit 122 for a given UI activated most recently. For example, when such given UI is activated and displayed as current UI, such cashed value for “sender_address” information may be read. A user can modify a sender address using the edition box 810. For example, a sender address can be input to the edition box 810, and such data can be customized for a user specific need (i.e., user customization).

The edition box 810 may read at a given timing. When the edition box 810 is read, and a modification is applied to a layout of UI parts of the edition box 810, different version identification value may be assigned to the UI. If condition setting data that should be displayed line by line is read without consideration to difference of version identification value for UI, data may not be displayed in the edition box 810 correctly. For example, different or non-relevant data may be displayed in the edition box 810, or no data may be displayed in the edition box 810. If such situation occurs, pre-existing data may not be used effectively (i.e., data may become useless), and re-input of data may be required and an input error may occur due to such re-input process.

In an example embodiment, the data inheritance unit 234 may be used as an interface for reading data. The data inheritance unit 234 may read pre-existing condition setting data using DOM, for example, and then inherit and set such pre-existing condition setting data for a new UI that should be displayed currently. Accordingly, pre-existing data can be efficiently and effectively utilized, and a vendor can efficiently design a UI when a given function is to be added or modified.

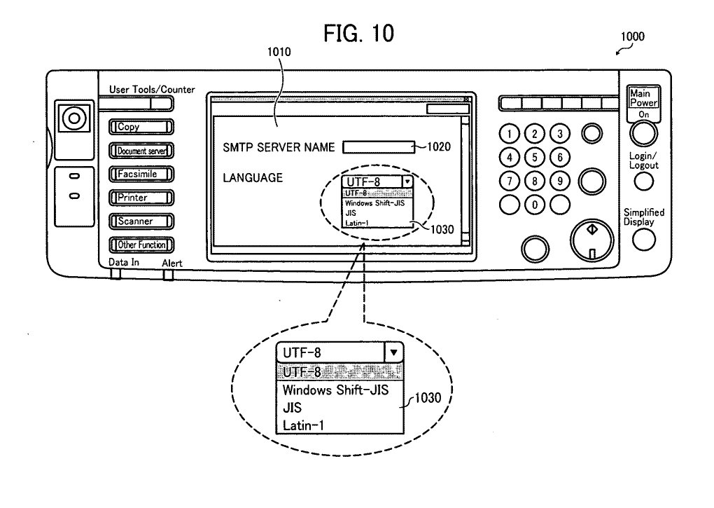

FIG. 10 illustrates an UI display 1000, which can be generated in an example embodiment. The UI display 1000 may be provided on an operation panel of the image forming apparatus 100 as an UI display depending on a configuration design of a processing node. Further, depending on the configuration design of the processing node, the UI display 1000 may be displayed on a display unit of PC 160 by emulating the UI display 1000 on the operation panel of the display unit of PC 160 (used as processing node). For example, the UI display 1000 may include a setting screen 1010 used for e-mail transmission function, which is included in a given workflow. The setting screen 1010 may display an edition box 1020 and a selection box 1030, for example. The edition box 1020 may be used to input a name/title of simple mail transfer protocol (SMTP) server used for e-mail transmission. The selection box 1030 may be used to select language encoding information, which can be used as typical language.

A user may use the setting screen 1010 displayed on the operation panel of the image forming apparatus 100 or a setting screen emulated on the display unit of PC 160, wherein the image forming apparatus 100 and the PC 160 may be used as a processing node. The user may input a SMTP server name in the edition box 1020, and set the language encoding information in the selection box 1030 such as “UTF-8,” for example. After such setting, an “OK” button is pressed to register the input value as condition setting data.

Such registered condition setting data may be overwritten over the condition setting data read by the program execution unit 122 as default data, by which a user can set customized condition setting data. If an UI architecture definition is modified while using same condition setting data, a management server, managing a workflow, may transmit only UI architecture definition, for example. Modification of UI architecture definition may typically be addition of item and change of layout. If condition setting data is just read without consideration to UI architecture definition when the UI architecture definition is modified, condition setting data set for a layout may not be effectively utilized for a changed layout of a processing node.

In an example embodiment, the data inheritance unit 234 using DOM or the like may read both of the UI architecture definition and condition setting data. As such, the UI architecture definition and the condition setting data can be read together, by which a workflow setting condition can be inherited for a processing node while effectively utilizing pre-existing condition setting data with consideration to the UI architecture definition. In an example embodiment, an UI architecture definition and condition setting data are separated with each other or mutually independent each other. Accordingly, when an UI configuration is to be set, a UI architecture definition can be customized for each one of users without modifying other data.

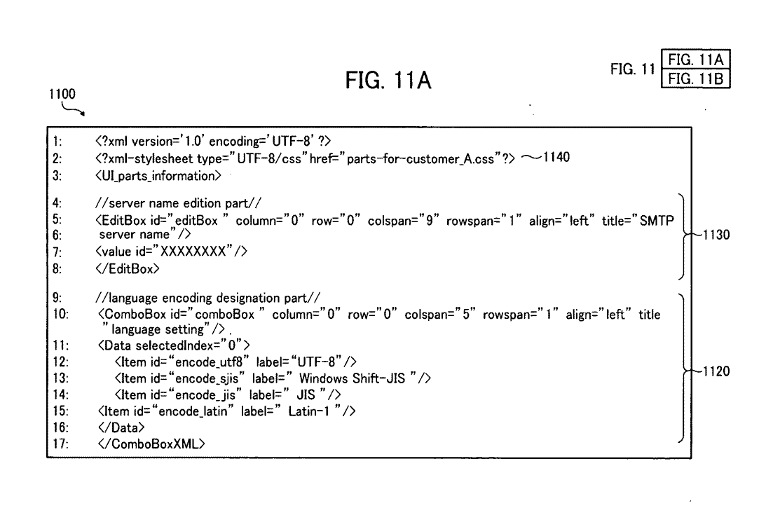

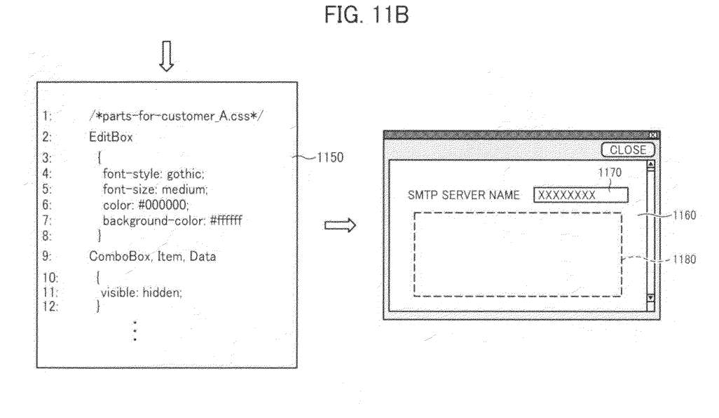

FIG. 11 illustrates a process of controlling an UI display for each one of users, in which the UI display 1000 shown in FIG. 10 may be used as one example. An UI architecture definition 1110 shown in FIG. 11 includes a description of UI parts such as a server name edition part 1130, and a language encoding designation part 1120, for example. Further, the UI architecture definition 1110 may include a description of “XML” line referring cascading style sheet (CSS), by which a display control of UI parts, provided for the UI architecture definition 1110, can be conducted. Such display control of UI parts may be defined by a UI display control file 1150, which is differently prepared with respect to the UI architecture definition 1110. When to modify a UI display for a processing node, used by the user, a management server or the PC 160 may transmit a UI display control file to the processing node disposed at a user site, in which the UI display control file can be used to switch setting of “display/non-display” style, for example. As such, when the UI architecture definition 1110 is read by the browser processing unit 220, a “display/non-display” control can be conducted based on the UI display control file 1150.

The UI display control file 1150 shown in FIG. 11 may be referred and linked to a file name having “href” property, but such reference format is not limited thereto, but the UI display control file 1150 can be linked to others such as a specific uniform resource locator (URL) or uniform resource identifier (URI), for example. As for a path designation, an absolute path designation or a relative path designation can be selected depending on types of installing style.

FIG. 11 illustrates the UI display control file 1150 according to an example embodiment, which can be described using any versions of CSS, for example, and further, can be described using others such as XML stylesheet language transformations (XSLT), but not limited thereto. As such, the UI display control file 1150 can be described given languages. Based on the UI display control file 1150, a setting screen 1160 can be displayed as shown in FIG. 11 based on the UI architecture definition 1110. The setting screen 1160 may display an input part 1170 to input a SMTP server name. A language encoding designation part can be displayed in a rectangular frame 1180, but not displayed in FIG. 11. As such, a user can select not to display a language encoding designation part, for example. As such, the display controller such as a browser processing unit can control a displaying style for the UI architecture definition. The browser processing unit may control display or non-display of UI parts provided by the UI architecture definition using a UI display control file transmitted via a network, for example. Such display or non-display selection may be one example of user customization. Such display control for UI parts can be conducted for any UI parts such as user access right, access authority, service agreement contents, or charge fee limitation. In an example embodiment, a user can easily customize a UI display without significant modification on UI architecture definition.

In the above described example embodiment, an image processing system can be devised. The image processing system includes the above described image processing apparatus disposed with a plurality of numbers in the image processing system, and a network connecting the plurality of image processing apparatuses with each other. In such image processing system, one of the image processing apparatuses may conduct information processing including a sequence of processing steps set for image data, or two or more of the image processing apparatuses may conduct information processing including a sequence of processing steps set for image data with a distributed processing manner.

In the above described example embodiment, a computer-readable medium storing a program for setting a user interface (UI) for an image processing apparatus is devised. The program includes instructions that when executed by a computer cause the computer to execute a method of setting the user interface (UI) for the image processing apparatus. The method includes the steps of obtaining, storing, reading, comparing, reading out, displaying, and executing. The obtaining obtains a UI architecture definition defining a configuration of the UI. The storing stores the UI architecture definition and condition setting data and condition setting data in a storage unit. The condition setting data is settable based on an interactive data operation using the UI, and useable for a process included in a workflow. The stored condition setting data is useable as pre-existing condition setting data. The reading reads the UI architecture definition. The comparing compares a version identification value of current UI architecture definition and a version identification value of most recently read UI architecture definition. When it is determined that the version identification value of current UI architecture definition and the version identification value of most recently read UI architecture definition are not identical, the reading out reads out the most recently used condition setting data from the storage unit as the pre-existing condition setting data. Based on the pre-existing condition setting data, the generating and storing generates and stores new condition setting data compatible with the UI architecture definition designated by the current UI architecture definition. The displaying displays a UI using the new condition setting data and interpreting the current UI architecture definition. The executing executes at least one processing step of information processing for image data using the new condition setting data.

Further, as for such computer-readable medium, the UI architecture definition is obtained as structured text via a network and stored in the storage unit.

Further, as for such computer-readable medium, the condition setting data is correlated with the UI architecture definition. The data inheritance unit reads the UI architecture definition, and compares a version identification value of current UI architecture definition and a version identification value of most recently read UI architecture definition. When it is determined from the version comparison that the version identification value of the current UI architecture definition and the version identification value of the most recently read UI architecture definition are not identical, the data inheritance unit reads out the pre-existing condition setting data used most recently from the storage unit, generates and sets the new condition setting data compatible with the current UI architecture definition.

Further, as for such computer-readable medium, the UI architecture definition and the condition setting data are mutually independent structured text, and the UI architecture definition and the condition setting data are correlated with each other to provide the UI, which is used for the information processing in the workflow that is to be executed for the image data. The information processing is executable by a plug-in program, and a UI corresponding to the plug-in program is prepared based on the UI architecture definition.

In an example embodiment, the above-described functions can be devised using an object-oriented programming such as C++, Java (registered trademark), Java (registered trademark) Script (registered trademark), Perl, Ruby, Python, which is executable by an information processing apparatus. In the above-described exemplary embodiment, a computer can be used with a computer-readable program for an information processing apparatus. For example, a particular computer may control the information processing apparatus using a computer-readable program, which can execute the above-described processes or steps. Further, in the above-described exemplary embodiments, a storage device (or recording medium), which can store computer-readable program, may be a hard disk drive, a compact disk read only memory (CD-ROM), a magneto optical disc (MO), a flexible disk, a memory card, a memory chip, an electrically erasable and programmable read only memory (EEPROM), an erasable programmable read only memory (EPROM) or the like, but not limited these. Such storage device (or recording medium) can be distributed with any distribution. Further, a computer-readable program can be downloaded to a particular computer (e.g., personal computer) via a network, or a computer-readable program can be installed to a particular computer from the above-mentioned storage device, by which the particular computer may be used for the information processing apparatus according to exemplary embodiment, for example. pre-existing Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An image processing apparatus including a user interface, comprising:
a user interface (UI) display unit to display the UI;
a UI architecture definition obtaining unit to obtain a UI architecture definition that defines a configuration of the UI;
a display controller to interpret the UI architecture definition and to display the UI on the UI display unit based on the interpretation of the UI architecture definition provided by the display controller;
a storage unit to store the UI architecture definition and condition setting data, the condition setting data settable based on an interactive data operation using the UI and useable for a process included in a workflow, the stored condition setting data useable as pre-existing condition setting data;
a data inheritance unit to read the pre-existing condition setting data, and to inherit the read pre-existing condition setting data as new condition setting data when the UI architecture definition is to be changed to a new UI architecture definition; and
a process execution unit to execute at least one processing step of information processing, included in the workflow, for image data of the image processing apparatus using the new condition setting data set by the data inheritance unit,
wherein the data inheritance unit reads the new UI architecture definition as current UI architecture definition, and compares a version identification value of current UI architecture definition and a version identification value of most recently read UI architecture definition, and when it is determined from the version comparison that the version identification value of the current UI architecture definition and the version identification value of the most recently read UI architecture definition are not identical, the data inheritance unit reads out the pre-existing condition setting data used most recently from the storage unit, generates the new condition setting data compatible with the current UI architecture definition, and stores the new condition setting data in the storage unit.

2. The image processing apparatus according to claim 1, wherein the UI architecture definition obtaining unit obtains the UI architecture definition as structured text via a network and stores the obtained UI architecture definition in the storage unit.

3. The image processing apparatus according to claim 1, wherein the condition setting data is correlated with the UI architecture definition, the data inheritance unit reads the UI architecture definition, and compares a version identification value of current UI architecture definition and a version identification value of most recently read UI architecture definition, and when it is determined from the version comparison that the version identification value of the current UI architecture definition and the version identification value of the most recently read UI architecture definition are not identical, the data inheritance unit reads out the pre-existing condition setting data used most recently from the storage unit, generates and sets the new condition setting data compatible with the current UI architecture definition.

4. The image processing apparatus according to claim 1, wherein the UI architecture definition and the condition setting data are mutually independent structured text, and the UI architecture definition and the condition setting data are correlated with each other to provide the UI, which is used for the information processing in the workflow that is to be executed for the image data.

5. The image processing apparatus according to claim 1, wherein the image processing apparatus is used as a processing node capable of executing the information processing including a sequence of processing steps set for processing the image data.

6. The image processing apparatus according to claim 1, wherein the information processing is executable by a plug-in program, and a UI corresponding to the plug-in program is prepared based on the UI architecture definition.

7. The image processing apparatus according to claim 1, wherein the display controller includes a browser processing unit, which controls a display style of the UI architecture definition, and the display controller controls display or non-display of UI part in the UI, the UI part provided by the UI architecture definition using a UI display control file transmitted via a network.

8. The image processing apparatus according to claim 5, wherein the sequence of information processing is set as a workflow for the image data including at least one of electronic mail transmission, file storage, facsimile transmission, and printing, and the information processing is executable by the processing node assigned for the workflow.

9. An information processing apparatus for providing a user interface (UI) used for managing processes executable by an image processing apparatus, the information processing apparatus comprising:
a UI architecture definition obtaining unit to obtain a UI architecture definition that defines a configuration of the UI;
a display controller to interpret the UI architecture definition and to display the UI on the UI display unit based on the interpretation of the UI architecture definition provided by the display controller;
a storage unit to store the UI architecture definition and condition setting data, the condition setting data settable based on an interactive data operation using the UI and useable for a process included in a workflow, the stored condition setting data useable as pre-existing condition setting data;
a network communication device to transmit the condition setting data as structured text to the image processing apparatus,
the information processing apparatus distributes the condition setting data to the image processing apparatus and instructs the image forming apparatus to read the condition setting data sequentially,
a data inheritance unit to read the pre-existing condition setting data, and to inherit the read pre-existing condition setting data as new condition setting data when the UI architecture definition is to be changed to a new UI architecture definition; and
a process execution unit to execute at least one processing step of information processing, included in the workflow, for image data of the image processing apparatus using the new condition setting data set by the data inheritance unit,
wherein the data inheritance unit reads the new UI architecture definition as current UI architecture definition, and compares a version identification value of current UI architecture definition and a version identification value of most recently read UI architecture definition, and when it is determined from the version comparison that the version identification value of the current UI architecture definition and the version identification value of the most recently read UI architecture definition are not identical, the data inheritance unit reads out the pre-existing condition setting data used most recently from the storage unit, generates the new condition setting data compatible with the current UI architecture definition, and stores the new condition setting data in the storage unit.

10. The information processing apparatus according to claim 9, wherein the condition setting data is correlated with the UI architecture definition,
the data inheritance unit reads the UI architecture definition, and compares a version identification value of current UI architecture definition and a version identification value of most recently read UI architecture definition, and when it is determined from the version comparison that the version identification value of the current UI architecture definition and the version identification value of the most recently read UI architecture definition are not identical,
the data inheritance unit reads out the pre-existing condition setting data used most recently from the storage unit, generates and sets the new condition setting data, compatible with the current UI architecture definition, designated by the version identification value of current UI, to inherit the condition setting data pre-existing in the image processing apparatus.

11. The information processing apparatus according to claim 9, wherein the image processing apparatus is used as a processing node capable of executing the information processing including a sequence of processing steps set for processing the image data.

12. The information processing apparatus according to claim 9, wherein the information processing is executable by a plug-in program, and a UI corresponding to the plug-in program is prepared based on the UI architecture definition.

13. A method of setting a user interface (UI) for an image processing apparatus, the method comprising the steps of:
obtaining a UI architecture definition defining a configuration of the UI;
storing the UI architecture definition and condition setting data and condition setting data in a storage unit, the condition setting data settable based on an interactive data operation using the UI, the condition setting data useable for a process included in a workflow, the stored condition setting data useable as pre-existing condition setting data;
reading the UI architecture definition;
comparing a version identification value of current UI architecture definition and a version identification value of most recently read UI architecture definition;
when it is determined that the version identification value of current UI architecture definition and the version identification value of most recently read UI architecture definition are not identical,
reading out the most recently used condition setting data from the storage unit as the pre-existing condition setting data;
based on the pre-existing condition setting data, generating and storing new condition setting data compatible with the UI architecture definition designated by the current UI architecture definition;
displaying a UI using the new condition setting data and interpreting the current UI architecture definition; and
executing at least one processing step of information processing for image data using the new condition setting data.

14. The method according to claim 13, wherein the UI architecture definition is obtained as structured text via a network and stored in the storage unit.

15. The user interface configuring method according to claim 13, wherein the image processing apparatus is used as a processing node for executing the information processing including a sequence of processing steps set for the image data, and a UI corresponding to a plug-in program usable for the information processing including is prepared based on the UI architecture definition.

16. The method according to claim 13, wherein the displaying of the UI includes controlling display or non-display of the UI provided by the UI architecture definition using a UI display control file transmitted via a network.
